(19) United States
(12) Patent Application Publication
(10) Pub. No.: US 2016/0059363 A1
(43) Pub. Date: Mar. 3, 2016

(54) PORTABLE COMPUTER NUMERICALLY CONTROLLED CUTTING MACHINE WITH FOLDING ARM

(71) Applicants: William Scott Ardisson, Pittsburgh, PA (US); Anthony Olivieri, Pittsburgh, PA (US); Michael Farmer, Monroeville, PA (US); James David White, Pittsburgh, PA (US)

(72) Inventors: William Scott Ardisson, Pittsburgh, PA (US); Anthony Olivieri, Pittsburgh, PA (US); Michael Farmer, Monroeville, PA (US); James David White, Pittsburgh, PA (US)

(73) Assignee: PITTSBURGH PORTABLE LASER COMPANY, LLC, Pittsburgh, PA (US)

(21) Appl. No.: 14/749,576

(22) Filed: Jun. 24, 2015

Related U.S. Application Data
(60) Provisional application No. 62/016,920, filed on Jun. 25, 2014.

(51) Int. Cl. B23K 37/02; B23K 26/38; B23K 26/06; B23K 26/00; B23K 26/08; B23K 26/70; B23K 37/00; B23K 10/00; B23K 26/03

(52) U.S. Cl. CPC B23K 37/0288; B23K 10/006; B23K 26/38; B23K 26/0648; B23K 26/032; B23K 26/0876; B23K 26/70; B23K 37/006; B23K 26/0096

(57) ABSTRACT

A portable computer numerically controlled non-contact cutting apparatus is provided comprising a housing, and an arm having a base portion attached to the housing and movable along a longitudinal axis of the housing. The arm may comprise a head assembly adapted to receive a cutting device, the head assembly may be movable along a longitudinal axis of the arm, and the arm may be rotatable about the base portion relative to the longitudinal axis of the housing from a retracted position to an extended position. Further, the arm may be adapted to be releasably held in the extended position.

### BACKGROUND OF THE INVENTION

1. Field of the Invention

The present invention relates to computer numerically controlled machines. More particularly, the present invention relates to a portable computer numerically controlled machine with a folding arm adapted to accommodate a non-contact cutting device.

2. Description of Related Art

Computer Numerically Controlled (CNC) machines typically take the form of a table that moves in the X and Y axes, and may include a tool spindle that moves in the Z direction (depth). The position of the tool is generally driven by motors. They can be used in a variety of applications, such as laser cutting, welding, friction stir welding, ultrasonic welding, flame and plasma cutting, bending, spinning, hole punching, pinning, gluing, fabric cutting, sewing, tape and fiber placement, routing, picking and placing, and sawing.

Typically, the cutting area of a non-contact CNC machine, such as a laser cutter or CNC plasma torch, is fully enclosed in a box. The material to be cut must be placed in the box, the lid is closed, and the cutting process started. The enclosed volume limits the size of the material that can be cut or marked with the tool. Since the cutting area of an enclosed laser is generally as large as the manufacturer can practically make it, the tool becomes large and unwieldy. Accordingly, such devices are typically only used in an industrial or commercial context.

### SUMMARY OF THE INVENTION

In order to address the limitations in the prior art, provided is a portable CNC non-contact cutting apparatus comprising a housing, and an arm having a base portion attached to the housing and movable along a longitudinal axis of the housing. The arm may comprise a head assembly adapted to receive a cutting device. The head assembly may be movable along a longitudinal axis of the arm, and the arm may be rotatable about the base portion relative to the longitudinal axis of the housing from a retracted position to an extended position. Further, the arm may be adapted to be releasably held in the extended position.

The cutting device may comprise a non-contact cutting tool, such as a plasma torch or a lens for focusing a laser beam. In the retracted position, the arm may be substantially parallel to the longitudinal axis of the housing, and in the extended position, the arm may be substantially perpendicular to the longitudinal axis of the housing.

The apparatus may further comprise a first drive mechanism for moving the base portion along the longitudinal axis of the housing and a second drive mechanism for moving the head assembly along the longitudinal axis of the arm. In additional non-limiting embodiments, the apparatus may further comprise a third drive mechanism for moving the head assembly in a direction substantially perpendicular to the longitudinal axis of the arm. The apparatus may further comprise at least one processor for controlling the movement of at least one of the first, second, and third drive mechanisms, and the at least one processor may be in communication with a computer or mobile device having a user interface.

The base portion of the arm may comprise a fastening device for retaining the arm in at least one of an extended position and a retracted position. The fastening device may comprise at least one magnet.

In a preferred, non-limiting embodiment, the base portion comprises a hinge support that is non-rotatable relative to the longitudinal axis of the housing and a hinge wing that is rotatable relative to the longitudinal axis of the housing, the hinge support and the hinge wing being arranged such that when the arm is rotated to at least one of a retracted position and an extended position, the hinge wing comes into contact with the hinge support and prevents further rotation.

The hinge wing may comprise at least a first magnet, and the hinge support may comprise at least a second magnet, and the first magnet and the second magnet may be arranged such that they come into contact with each other when the arm is rotated into an extended position.

In a preferred, non-limiting embodiment, the head assembly comprises a vacuum line port. Further, at least a portion of a vacuum system may be contained within the housing and the vacuum system may be adapted to be connected to the vacuum line port.

Additionally, the head assembly may further comprise a camera in communication with the at least one processor. When the housing is moved after a first set of cuts has been made, the at least one processor may be configured to automatically align the head assembly relative to the first set of cuts based at least partially on data from the camera.

In further non-limiting embodiments, the housing may further comprise a foldable cutting surface. The cutting surface may be comprised of a plurality of expanded metal sections adapted to be rolled out in a direction perpendicular to the longitudinal axis of the housing.

The head assembly may further comprise a safety device in communication with at least one processor and configured to prevent the apparatus from operating if the cutting device is greater than a predetermined distance from a surface. For example, the safety device may comprise a camera, a physical contact switch, an optical distance finder, or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various Figs. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1A shows an overhead perspective view of a portable laser cutting apparatus in accordance with a non-limiting embodiment of the present invention.

FIG. 1B shows an overhead view of the non-limiting embodiment shown in FIG. 1A, with the top portion of the housing removed.

FIG. 2 shows a perspective view of the portable laser cutting apparatus shown in the preceding Figs. with the folding arm in the extended position.

FIGS. 3A and 3B show two perspective views of the folding arm mechanism of the portable cutting apparatus shown in the preceding Figs. with inter alia the housing and laser head assembly cut away in order to show detail.

FIG. 4 shows a side view of the portable laser cutting apparatus shown in FIGS. 1A-B and 2 with the arm in the retracted position.

FIGS. 5A and 5B show two perspective views of the folding arm mechanism as shown in FIGS. 3A and 3B, but with the folding arm in the retracted position.

FIG. 6 shows a close up view of the embodiment shown in the preceding Figs., focused on the base portion of the folding arm.

FIGS. 7A-H show perspective views from various angles of the base portion of the arm as illustrated in the preceding Figs.

FIG. 8A shows a close-up perspective view of the base portion of the folding arm from the exterior side of the hinge while the folding arm is in the retracted position.

FIG. 8B shows a close-up perspective view looking down the exterior side of the folding arm toward the housing when the folding arm is in the extended position.

FIG. 9 shows a close-up perspective view of the head assembly as viewed facing away from the housing when the arm is in the extended position.

FIGS. 10A-D show a cutting device adapted for laser cutting applications comprising a vacuum system in accordance with a non-limiting embodiment of the present invention.

FIGS. 11A-B show different views of how the cutting device of the non-limiting embodiment shown in FIGS. 10a-d may be attached to the head assembly.

FIGS. 11C-E show a drive mechanism comprising a beam shield in accordance with a non-limiting embodiment of the present invention

FIG. 12 shows a diagram of the embodiment of the drive mechanism shown in FIGS. 11A-E with the shield 802 removed.

### DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing Figs. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt, transmission, or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature and may not be necessarily immediate. Additionally, two units or devices may be in communication with each other even though the data transmitted may be modified, processed, routed, etc., between the first and second unit or device. It will be appreciated that numerous other arrangements are possible. In addition, as used hereinafter, the term “generate” includes the direct or indirect act of generating or causing the generation (or creation) of data, a data structure, an interface, information, content, or the like.

The present invention addresses some of the limitations of the prior art by using a folding gantry arm for one axis of the laser head positioning system. In a preferred non-limiting embodiment, the gantry can fold out for cutting and then fold back in for transportation. In a preferred non-limiting embodiment, the apparatus may comprise a folding hinge mechanism that may use magnets to both align and secure the arm into its operating position by constraining two precision machined faces together. This mechanism provides tactile feedback to the user with a “detent” feel that indicates that the gantry arm is fully deployed and ready for use, and may also provide a degree of shock absorption if the arm is bumped while in use. A controller, such as a computer in communication with at least one processor integrated into the device, may be provided to control the direction, intensity, speed of movement, and spread of the laser beam aimed at the surface.

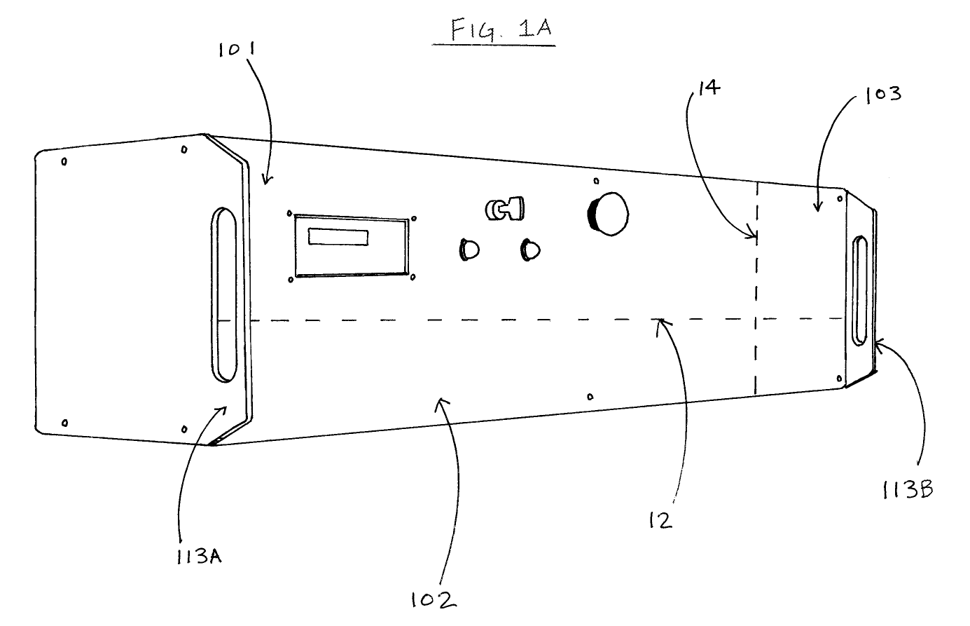

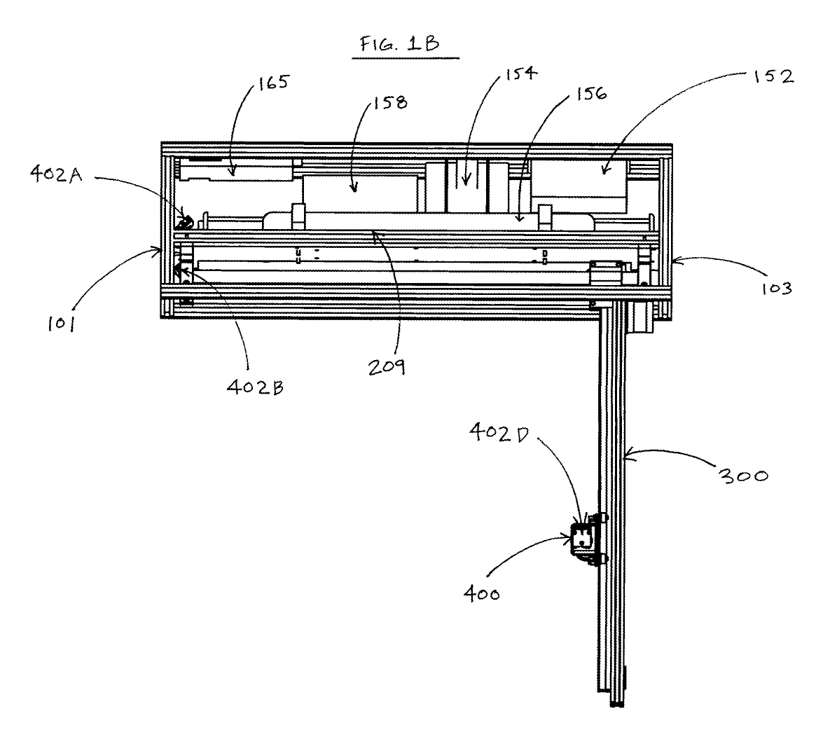

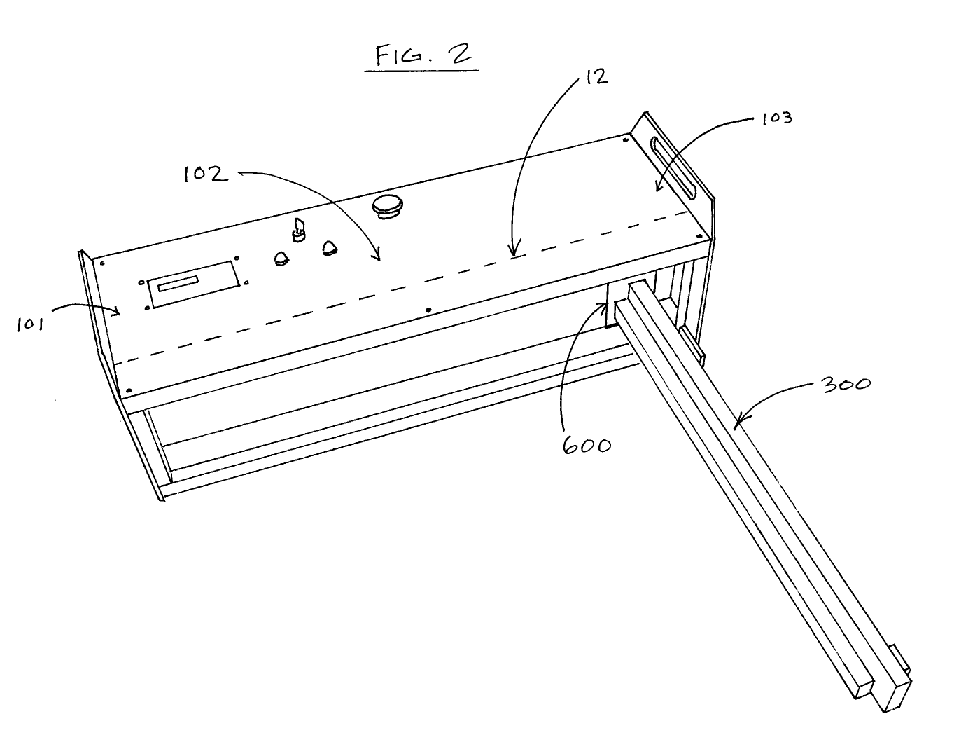

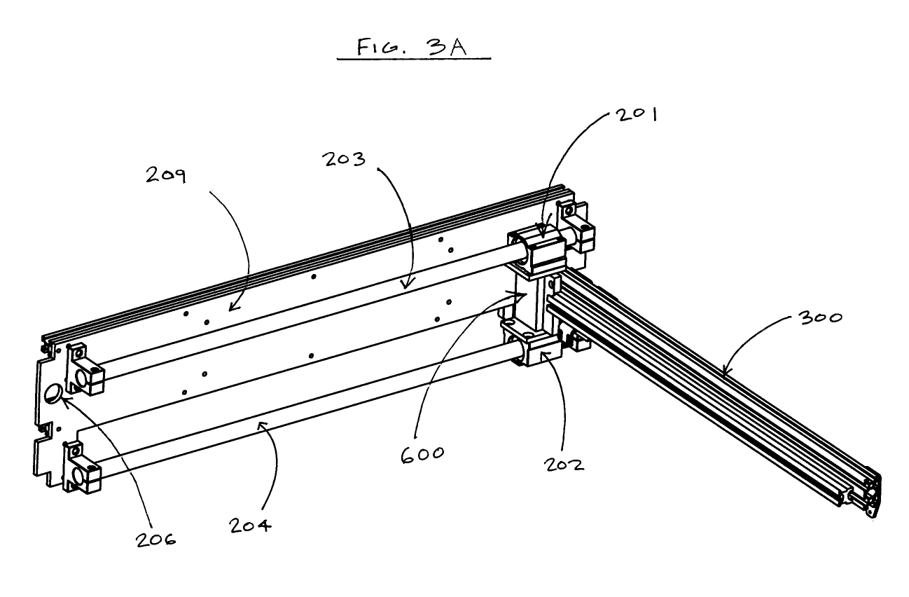

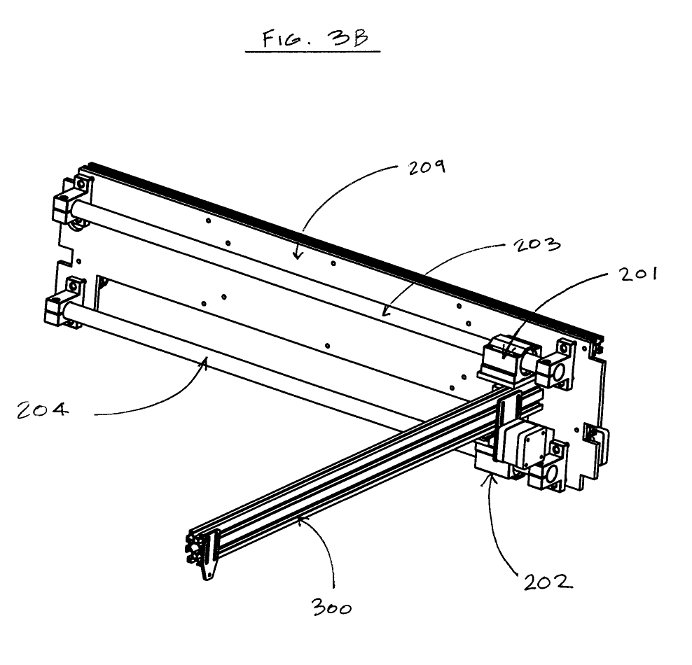

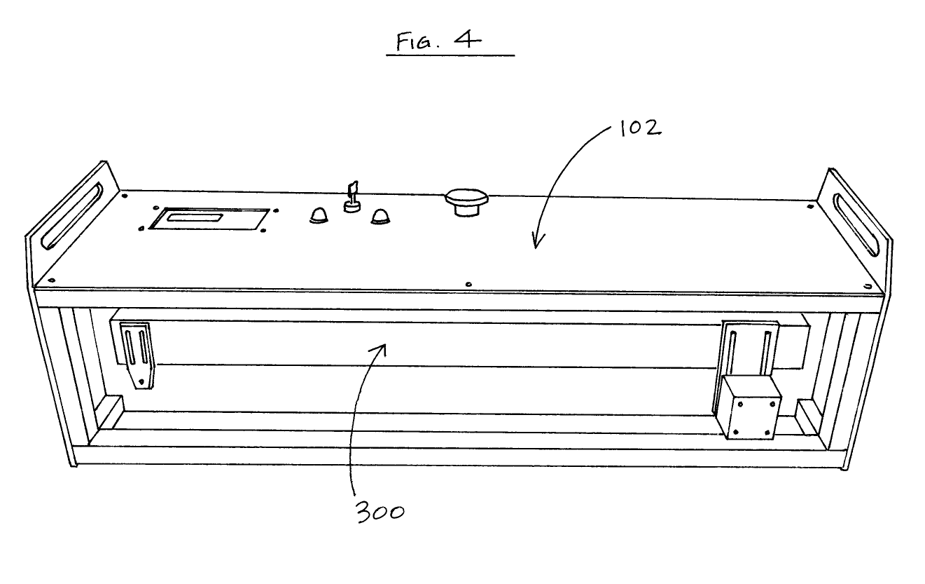

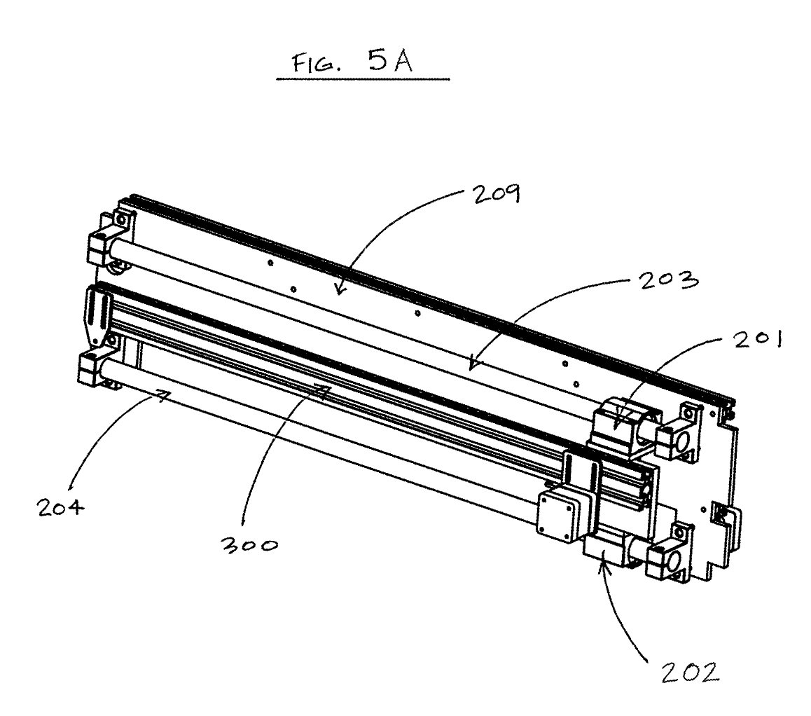

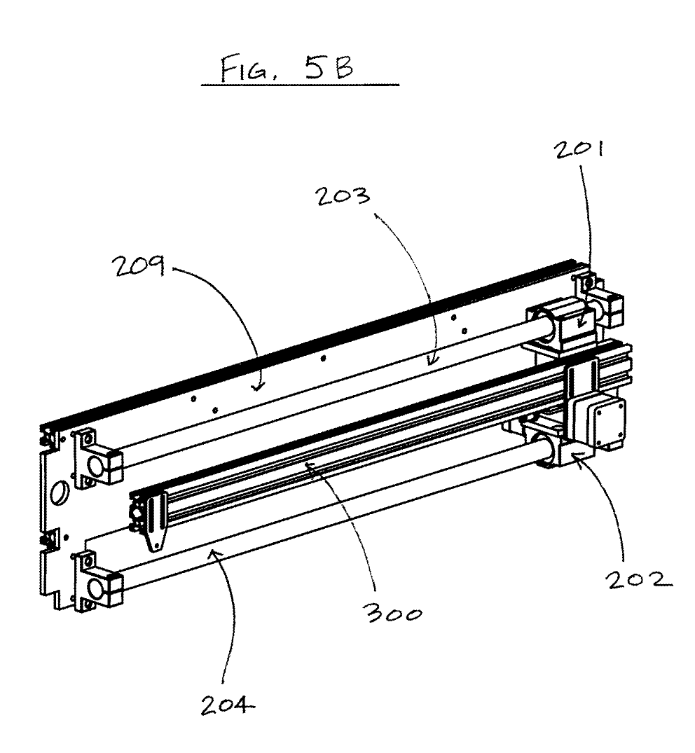

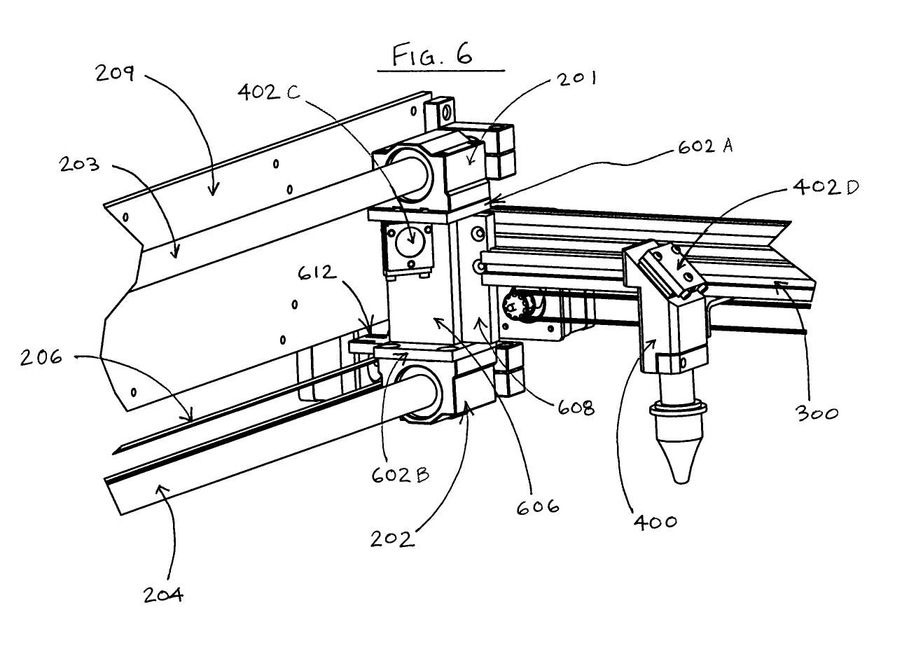

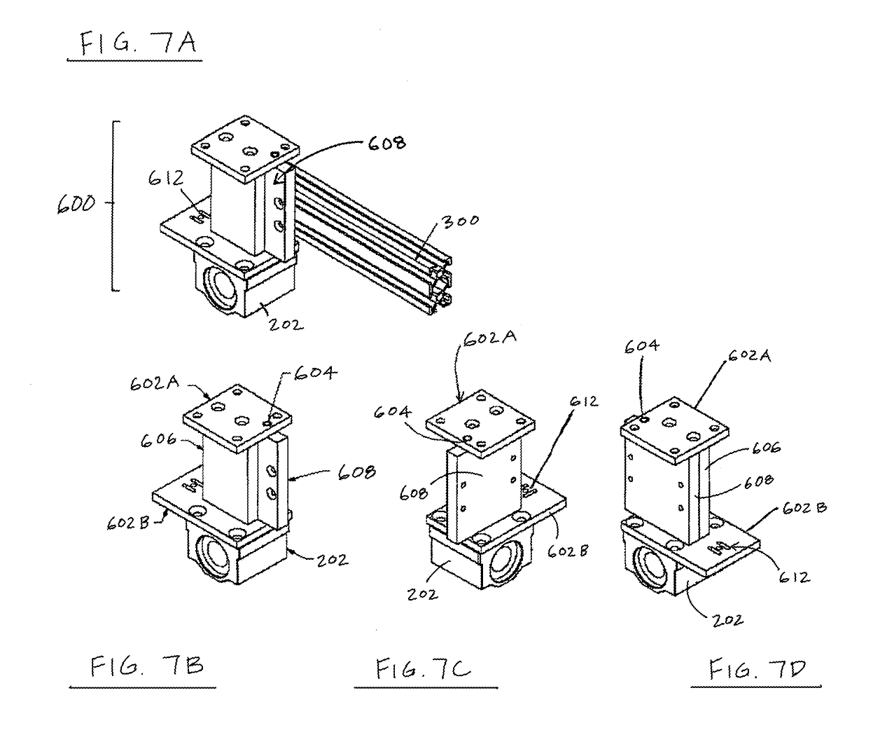

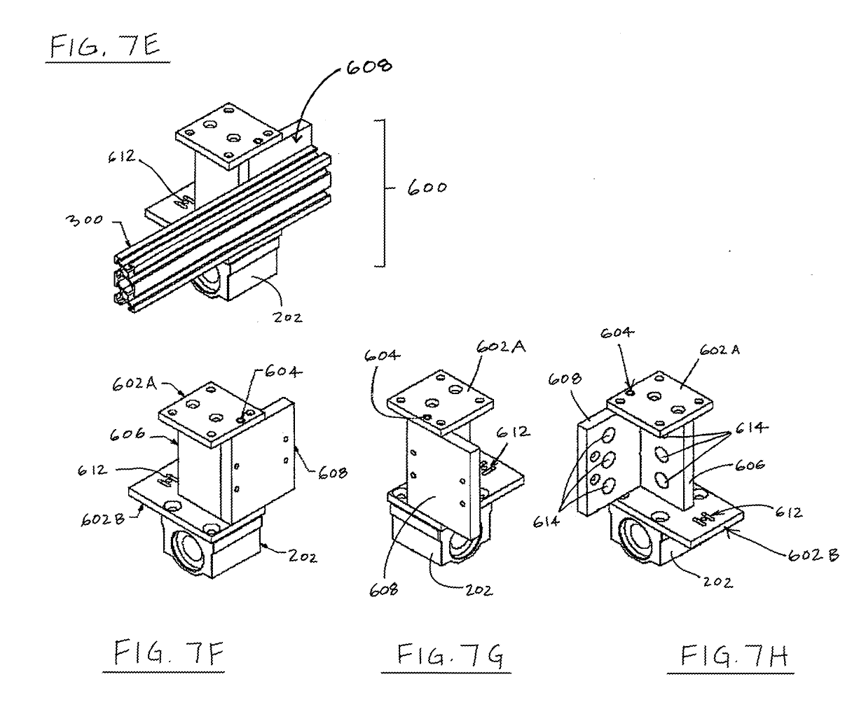

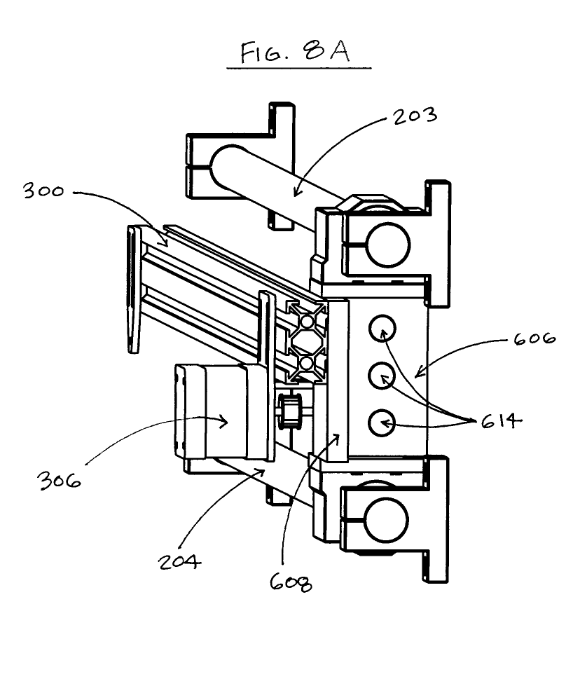

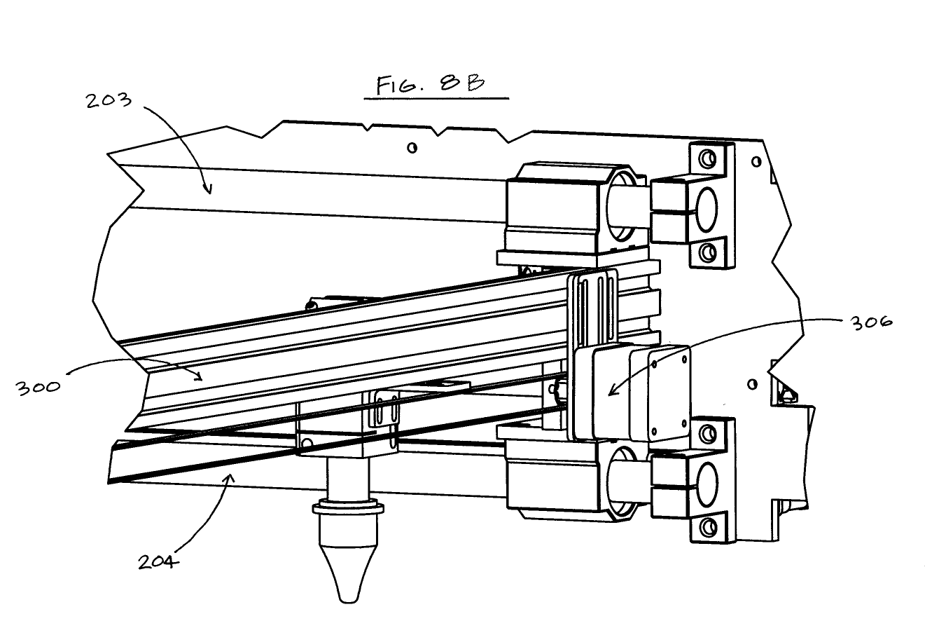

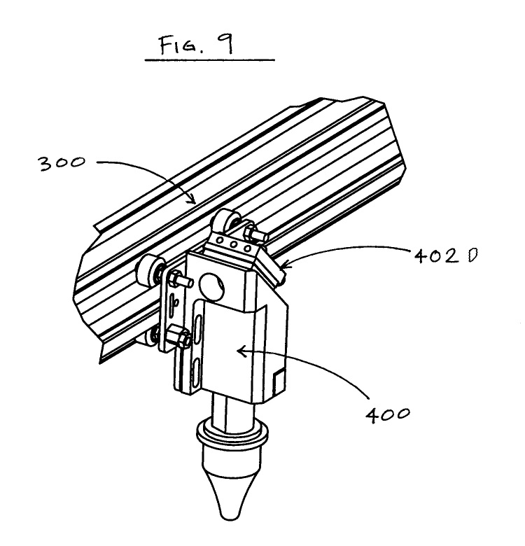

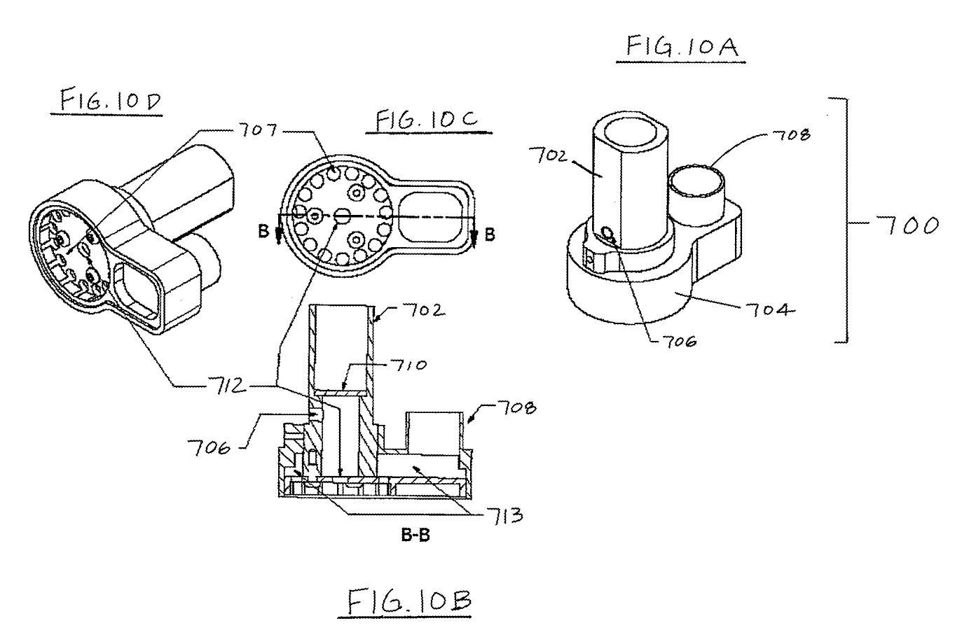

FIG. 1A shows an overhead perspective view of a portable laser cutting apparatus in accordance with a non-limiting embodiment of the present invention. In the non-limiting embodiment shown, a housing 102 contains a laser emitting system with a folding arm mechanism. The housing has a first end 101 wherein the end portion of a folding arm 300 (not visible in figure because the arm is retracted) is contained when it is in the retracted position and a second end 103 wherein a base portion 600 (also not visible in figure because the arm is retracted) is contained when the folding arm 300 is in the retracted position. In the non-limiting embodiment shown, two carrying handles 113A, 113B are provided to facilitate transportation of the apparatus.

The housing has a longitudinal axis 12 which corresponds to the y-axis of the head assembly when the apparatus is in operation and a transverse axis 14 which corresponds to the x-axis of the head assembly when the apparatus is in operation. In the non-limiting embodiment shown, the housing is a partially enclosed box which protects the internal components of the apparatus. However, this feature is not intended to be limiting, and any frame-type structure is permissible including, but not limited to, an unenclosed frame, so long as the housing provides a fixed structure along which the base portion of the arm may be moved.

As used herein, extended position refers to a position wherein the arm 300 is extended away from the housing 102 such that the head assembly may operate on an article not located within or underneath the housing. In a preferred non-limiting embodiment, the arm is substantially perpendicular to the longitudinal axis 12 of the housing 102 when the arm is in the extended position and substantially parallel to the longitudinal axis 12 of the housing 102 when the arm is in the retracted position.

In the preferred non-limiting embodiment shown, when the arm is in the retracted position, the arm is located inside of the housing to facilitate transportation and to protect the arm and head assembly. However, alternative configurations are envisioned and are deemed to be within the spirit of the invention. For example, the arm may remain external to the housing in the retracted position and be positioned proximate to and substantially parallel to the housing in order to improve portability.

FIG. 1B shows an overhead view of the non-limiting embodiment shown in FIG. 1A, with the top portion of the housing removed. In the non-limiting embodiment shown, the housing comprises a back plate 209 which separates the folding arm mechanism from a laser emitting system. During operation, the laser emitting system emits a beam toward the first end 101 of the housing along the longitudinal axis 12 of the housing. The beam is reflected by a plurality of reflectors 402A-D (402C is hidden in the figure) and then focused onto a surface on which the laser is intended to operate via a head assembly 400.

Also visible in FIG. 1B are a power supply 152 used to power the laser, a laser tube 156, a cooling unit 158 for cooling the laser tube 156, and a vacuum system 154. In a preferred non-limiting embodiment, the vacuum system 154 may be connected to a hose (not shown) running to the head assembly 400. The vacuum allows for the removal of debris, noxious fumes, and other materials which may result from cutting a surface with a laser or other non-contact cutting system, and which might otherwise interfere with the cutting operation or pose a danger to the user.

The housing may comprise at least one processor 165 for controlling a first drive mechanism for moving the base portion along the longitudinal axis of the housing and a second drive mechanism for moving the head assembly along the longitudinal axis of the arm. Further, the at least one processor 165 may control the pulse rate and intensity of the beam. In the preferred non-limiting embodiment shown, each of the first and second drive mechanisms comprises a belt-and-pulley mechanism, although any drive mechanism is permissible, for example, a rack-and-pinion mechanism could also be used.

The at least one processor may be in communication with a computer, mobile device, and/or second processor having a user interface whereby the user or a computer program can control the movement of the head assembly on an x axis and a y axis by coordinating the movement of the first and second drive mechanisms. Further, the at least one processor may control the pulse rate and intensity of the laser or other non-contact cutting device. In additional non-limiting embodiments, the head assembly may also comprise an additional drive mechanism in communication with the at least one processor for moving the cutting device up and down along a z axis.

A variety of types of lasers may be used with the present invention. In non-limiting examples, a C02 laser is particularly suited for cutting, boring, and engraving applications, a neodymium (Nd) laser is particularly suitable for boring applications where high energy but low repetition are required, and a neodymium yttrium-aluminum-garnet (Nd—YAG) laser is particularly suitable where very high power is needed.

However, the present invention is not limited to laser cutters alone. In an additional non-limiting embodiment, a plasma torch or similar non-contact cutting device may be used in place of the laser cutting device. Including a z-axis drive mechanism is particularly advantageous in such embodiments. In further non-limiting embodiments, an electric discharge machine or water jet cutter may also be used in place of a laser cutting head.

FIG. 2 shows a perspective view of a portable laser cutter with the arm in the extended position in accordance with a non-limiting embodiment of the present invention. In the non-limiting embodiment shown, the housing 102 contains a laser emitting element (not visible) and a folding arm mechanism. The folding arm mechanism comprises an arm 300 attached to a base portion 600 which allows the arm 300 to move laterally along the longitudinal axis 12 of the housing 102 and to rotate away from the housing 102 to an unfolded position.

The base portion 600 is movable along the longitudinal axis 12 of the housing 102 such that movement of the base portion 600 corresponds to y-axis movement of the arm 300. In the non-limiting embodiment shown, the base portion comprises a bearing block 202 comprising a linear bearing which is stabilized by a linear shaft 204 which is affixed to a first end 101 of the housing 102 and a second end 103 of the housing in the vicinity of which the base portion 600 is normally located when the arm 300 is in the refracted state.

FIG. 3A shows a view of the folding arm mechanism of the non-limiting embodiment illustrated in the preceding Figs. with the exterior of the housing cut away. A second linear shaft 203 may also be provided to improve the stability of the base portion 600 of the arm. In the non-limiting embodiment shown, the laser emitting system (not shown) is located behind the back plate 209 of the folding arm mechanism, and the laser beam is directed through a laser output hole 206 and onto the reflector 402b (not shown).

In a preferred non-limiting embodiment, the back plate 209 further comprises a second linear bearing 201 affixed to a second linear shaft which is also affixed to the first and second housing ends 101 and 103 of the housing 102 in order to provide additional stability and support. Preferably, the second linear bearing is of a type that allows for some vertical movement relative to the second linear shaft to reduce the risk of the machine becoming inhibited in the event that the base portion does not move evenly along the linear shafts.

FIG. 3B shows another perspective view of the illustration of FIG. 3A.

FIG. 4 shows a side view of the portable laser cutting apparatus shown in FIGS. 1A-B and 2A-B with the arm in the refracted position.

FIGS. 5A and 5B show two perspective views of the folding arm mechanism as shown in FIGS. 3A and 3B, but with the folding arm in the retracted position.

FIG. 6 shows a close up view of the non-limiting embodiment shown in the preceding Figs., focused on the base portion 600 of the folding arm 300. As can be better seen in FIG. 6, the base portion 600 may comprise a hinge portion comprising an upright hinge support 606 and a hinge wing 608 to which the arm 300 is mounted. In the non-limiting embodiment shown, the upright hinge support 606 is non-rotatably fixed to a top mounting plate 602A and a bottom mounting plate 602B, the bottom mounting plate being affixed to the bearing block 202 which is supported by and slidably movable along a linear shaft 204. The hinge wing 608 is rotatably movable about a hinge pin (not visible) such that it allows the arm 300 to rotate relative to the housing 102 (not shown) between the extended and retracted positions. The top mounting plate 602A may also be affixed to a second bearing block 201 which is supported by and slidable along a second linear shaft 203. The bottom mounting plate 602B further comprises one or more drive mounting holes 612, which allow the base portion 600 to be connected to a drive mechanism 206 which allows the base portion 600 to move along the longitudinal axis 12 of the housing 102. In the non-limiting embodiment shown, the drive mechanism is a belt drive type mechanism however any readily controllable means of moving the base portion along the longitudinal axis of the housing is permissible and considered to be within the spirit of the present invention.

Also visible in FIG. 6 are two reflectors 402C-D (the front side of 402C is visible and the back side of 402D is visible in the figure). In the non-limiting embodiment shown, the laser beam is bounced off of reflector 402C and directed down through the head assembly 400 by reflector 402D.

FIGS. 7A-H show perspective views from various angles of the base portion 600 of the arm as illustrated in the preceding Figs. In each illustration of the non-limiting embodiment shown, the drive belt mounting holes 612 are understood to be on the side of the base portion 600. In FIGS. 7A-D, the hinge portion of the base portion is positioned such that the arm 300 is in the extended position, substantially perpendicular to the direction of the linear bearing 202, while in FIGS. 7E-H the hinge portion of the base portion is positioned such that the arm is in the retracted position, substantially parallel to the direction of the linear bearing 202. In FIGS. 7A and 7E, the arm 300 is shown connected to the hinge wing 608 while in FIGS. 7B-D and 7F-H the arm has been removed. For orientation purposes, note that in each of FIGS. 7A-H, the drive belt mounting holes 612 are located on the side of the base portion 600 that is proximate to the housing, and that the direction of the linear bearing 202 is parallel to the longitudinal axis 12 of the housing 102.

As can be seen in FIG. 7B, the hinge portion comprises an upright hinge support 606 which is non-rotatable relative to the mounting plates and a hinge wing 608 which is rotatable relative to the mounting plates about a hinge pin 604. The arm 300 is affixed to the hinge wing 608 which allows it to rotate between the extended and retracted positions. Further, the interaction between the upright hinge support 606 and the hinge wing 608 limits the rotation of the arm to 90 degrees and stabilizes the arm when it is either fully retracted or fully extended.

As can be seen in FIG. 7H, in the non-limiting embodiment shown, the folding hinge mechanism uses magnets to both align and secure the arm into its operating position by constraining two precision machined faces together. Specifically, the hinge wing 608 and the upright hinge support 606 are each equipped with a plurality of corresponding magnets 614. The magnets are aligned such that each magnet on the hinge wing 608 is attracted to a corresponding magnet on the hinge support 606 and comes into contact therewith when the arm 300 is placed in the extended position (as shown in FIGS. 7A-D). This mechanism provides tactile feedback to the user with a “detent” feel that indicates that the arm is fully deployed and ready for use. The mechanism also provides a degree of shock absorption if the arm is bumped while in use.

FIG. 8A shows a close-up perspective view of the base portion of the folding arm from the exterior side of the hinge while the folding arm is in the retracted position. As can be seen from this perspective, the arm 300 comprises a second drive mechanism 306, which controllably moves the head assembly along the arm 300. This allows for x-axis 14 movement of the head assembly 400 when the arm 300 is in the extended position. In the non-limiting embodiment shown, the drive mechanism comprises an electric motor and a belt and pulley mechanism.

FIG. 8B shows a close-up perspective view looking down the exterior side of the folding arm toward the housing when the folding arm is in the extended position.

FIG. 9 shows a close-up perspective view of the head assembly 400 adapted for receiving a cutting device, as viewed facing away from the housing when the arm is in the extended position. The non-limiting embodiment shown comprises a reflector 402d attached thereto to adapt the head assembly 400 for use with a laser cutter.

FIGS. 10A-D show a cutting device 700 in accordance with a non-limiting embodiment of the present invention. In the non-limiting embodiment shown, the cutting device is a laser cutting head comprising an integrated vacuum system. The cutting head comprises a cutting head support tube 702 which is affixed to a head assembly and through which the laser passes downward. The cutting head support tube 702 comprises a lens 710. In a preferred non-limiting embodiment, the lens is electronically movable upward and downward using a drive mechanism in communication with the processor such that the laser can be focused either automatically or in response to user-inputted commands.

In the preferred non-limiting embodiment shown, the cutting head comprises a vacuum line port 708 for fume extraction. While in operation, a hose (not shown) may be connected to the vacuum line port 708 and further connected to a vacuum system 154, which may be integrated into the housing (see FIG. 1B) or may be an external device. The hose may move along with the head assembly during operation. The vacuum allows for the removal of debris, noxious fumes, and other materials which may result from cutting a surface with a laser or other non-contact cutting system, and which might otherwise interfere with the cutting operation or pose a danger to the user.

In order to facilitate the operation of the vacuum system, the bottom portion 704 of the cutting head may comprise a plurality of ventilation holes 707 which lead into a connected air chamber 713 within the bottom portion 704 of the cutting head and surrounding the cutting head support tube 702. The connected air chamber 713 may lead toward the vacuum line port 708 such that debris and fumes are pulled away from the path of the laser and the surface to be cut.

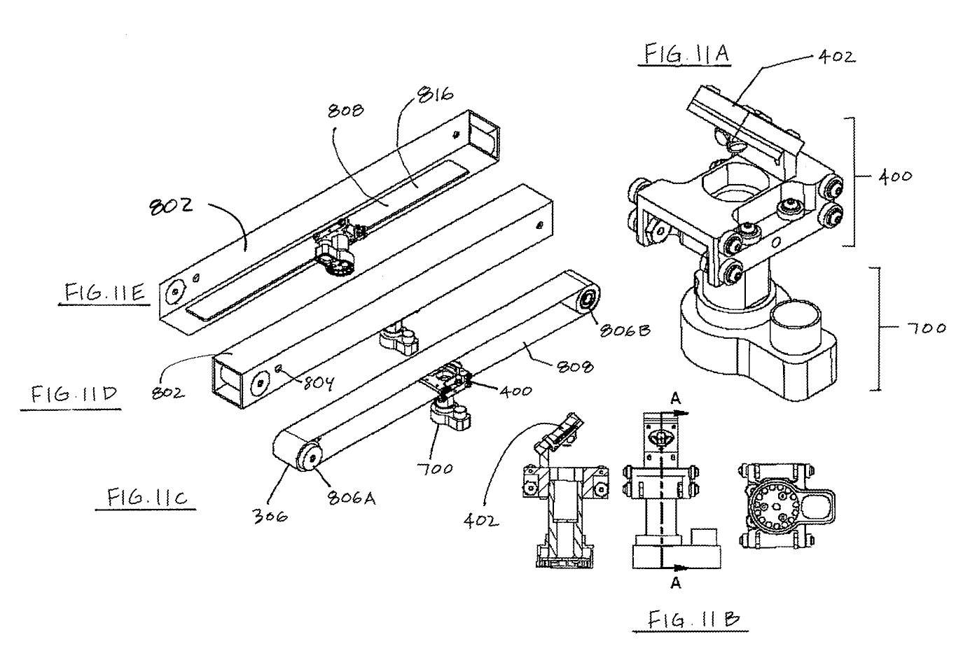

FIGS. 11A-B show different views of a head assembly 400 having a reflector 402 and the cutting device 700 shown in FIGS. 10A-D attached thereto in accordance with a non-limiting embodiment of the present invention.

FIGS. 11C-11E show a head assembly 400 and cutting device 700 mounted on a drive mechanism 306 which uses a belt 808 thereof as a beam shield. Lasers of the type used in cutting and engraving may pose a danger to the user or any objects that may come in contact with the beam path. Accordingly, it is advantageous to provide as much shielding as possible around the path of the laser without interfering with the path of the beam. In the preferred non-limiting embodiment shown, the drive mechanism comprises a belt 808 and two pulleys 806a, 806b, driven by a motor in communication with a processor (not shown). Further, the head assembly 400 may be mounted such that it surrounds a section of the bottom portion of the belt, as shown in FIG. 11C. When the preferred non-limiting embodiment shown is utilized in laser cutting applications, the head assembly has a reflector 402 mounted thereto facing down the longitudinal axis of the drive mechanism 306 towards the housing (not shown) such that the laser may be passed through the middle of the belt 808 using a reflector (not shown) such that the belt itself provides shielding on the beam in the upward and downward directions.

As shown in FIGS. 11D-E, the beam path may be provided with additional shielding on the sides and top of the drive mechanism 306 by surrounding the drive mechanism 306 with a shield comprising a laser entrance port 804. In the non-limiting embodiment shown in FIG. 11E, the shield 802 comprises an opening 816 extending along its longitudinal axis to allow movement of the head assembly 400 along with the belt 808.

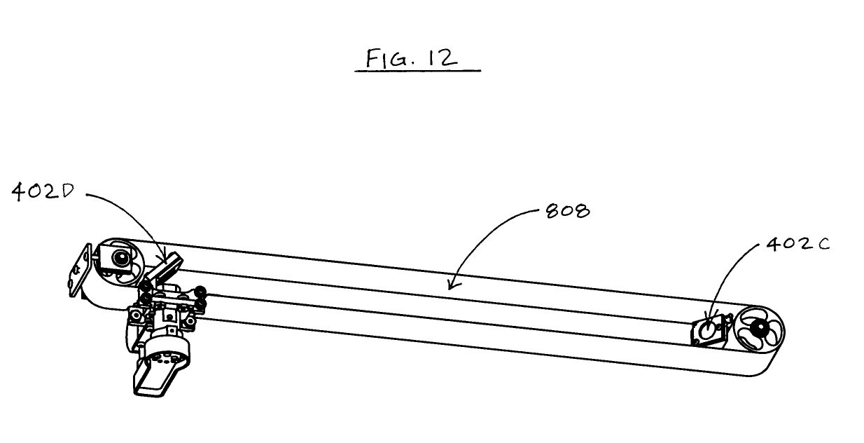

FIG. 12 shows a diagram of the embodiment of the drive mechanism shown in FIGS. 11A-E with the shield 802 removed. As can better be seen in FIG. 12, the beam may be bounced off of a reflector 402c positioned in between the top and bottom portions of the belt 808 (and which may, for example, be mounted on the arm (not shown) which reflects the beam to another reflector 402d mounted on the head assembly.

In additional non-limiting embodiments, a camera or other optical device may be affixed to the head assembly and be in communication with at least one processor and provide the user with a close-up visual display. Further, the camera in conjunction with the processor may be configured to automatically align the head assembly relative to previous cuts such that a larger area can be worked on.

In additional non-limiting embodiments, the head assembly may comprise a safety mechanism using, for example, a camera, physical contact switch, or optical distance finder to prevent the laser from operating unless it is proximate to a surface.

In additional non-limiting embodiments, the housing may further comprise a foldable cutting surface which may be made of, for example, expanded metal, which may be rolled up into the housing during storage and rolled out to cover at least a portion of the area on which the cutting device may operate during operation.

This invention has been described with reference to the preferred embodiments. Obvious modifications and alterations will occur to others upon reading and understanding the preceding detailed description. It is intended that the invention be construed as including all such modifications and alterations.

The invention claimed is:

1. A portable computer numerically controlled non-contact cutting apparatus comprising:
a housing;
an arm having a base portion attached to the housing, the base portion being movable along a longitudinal axis of the housing, the arm comprising a head assembly adapted to receive a cutting device, the head assembly being movable along a longitudinal axis of the arm;
wherein the arm is rotatable about the base portion relative to the longitudinal axis of the housing from a retracted position to an extended position; and
wherein the arm is adapted to be releasably held in the extended position.

2. The apparatus of claim 1, wherein the cutting device comprises a lens for focusing a laser beam.

3. The apparatus of claim 1, wherein the cutting device comprises a plasma torch:

4. The apparatus of claim 1, wherein in the retracted position, the arm is substantially parallel to the longitudinal axis of the housing, and wherein in the extended position, the arm is substantially perpendicular to the longitudinal axis of the housing.

5. The apparatus of claim 1, further comprising a first drive mechanism for moving the base portion along the longitudinal axis of the housing and a second drive mechanism for moving the head assembly along the longitudinal axis of the arm.

6. The apparatus of claim 5, further comprising a third drive mechanism for moving the head assembly in a direction substantially perpendicular to the longitudinal axis of the arm.

7. The apparatus of claim 5, further comprising at least one processor for controlling the movement of at least one of the first drive mechanism and the second drive mechanism.

8. The apparatus of claim 7, wherein the at least one processor is in communication with a computer or mobile device having a user interface.

9. The apparatus of claim 1, wherein the base portion comprises a fastening device for retaining the arm in at least one of an extended position and a retracted position.

10. The apparatus of claim 9, wherein the fastening device comprises at least one magnet.

11. The apparatus of claim 1, wherein the base portion comprises a hinge support that is non-rotatable relative to the longitudinal axis of the housing and a hinge wing that is rotatable relative to the longitudinal axis of the housing, the hinge support and the hinge wing being arranged such that when the arm is rotated to at least one of a retracted position and an extended position, the hinge wing comes into contact with the hinge support and prevents further rotation.

12. The apparatus of claim 11, wherein the hinge wing comprises at least a first magnet, and the hinge support comprises at least a second magnet, wherein the first magnet and the second magnet are arranged such that they come into contact with each other when the arm is rotated into an extended position.

13. The apparatus of claim 1, wherein the head assembly comprises a vacuum line port.

14. The apparatus of claim 13, wherein at least a portion of a vacuum system is contained within the housing and the vacuum system is adapted to be connected to the vacuum line port.

15. The apparatus of claim 1, wherein the head assembly further comprises a camera in communication with at least one processor.

16. The apparatus of claim 15, wherein when the housing is moved after a first set of cuts has been made, the at least one processor is configured to automatically align the head assembly relative to the first set of cuts based at least partially on data from the camera.

17. The apparatus of claim 1, wherein the housing further comprises a foldable cutting surface.

18. The apparatus of claim 17, wherein the foldable cutting surface comprises a plurality of expanded metal sections adapted to be rolled out in a direction perpendicular to the longitudinal axis of the housing.

19. The apparatus of claim 1, further comprising a safety device in communication with at least one processor and configured to prevent the apparatus from operating if the cutting device is greater than a predetermined distance from a surface.

20. The apparatus of claim 19, wherein the safety device comprises a camera, a physical contact switch, an optical distance finder, or any combination thereof.
